(19) United States
(12) Patent Application Publication
(10) Pub. No.: US 2017/0095908 A1
(43) Pub. Date: Apr. 6, 2017

(54) DIAPHRAGM PLIERS

(71) Applicant: Pelleossa S.r.l., Massa (IT)

(72) Inventor: Paolo ELMI, MASSA (IT)

(21) Appl. No.: 15/286,147

(22) Filed: Oct. 5, 2016

(30) Foreign Application Priority Data
Oct. 6, 2015 (IT) 102015000058737

(51) Int. Cl. B25B 7/04; B25B 7/12; B25B 7/22

(52) U.S. Cl. CPC B25B 7/04; B25B 7/22; B25B 7/12

(57) ABSTRACT

An apparatus, an adjustable tool with variable diameter aimed at tightening and twisting nuts, bolts or other prismatic objects, with polygonal section or circular section outlines suitable for performing several actions around different kinds of objects, working on such objects through two different ways to move a variable number of teeth, which, while working, close like a diaphragm around the sides of such objects, perfectly adapting to their diameter and their section or capacity.

### CROSS REFERENCE TO RELATED APPLICATIONS

The present application claims priority to Italian patent application 102015000058737 filed on Oct. 6, 2015, the contents of which are incorporated herein by reference in their entirety.

### FIELD

The present disclosure relates to the field of pliers, spanner hand tools sector, or as an operating end of electronic hand tools and robotic arms designed to grip and engage nuts, bolts and other items namely the hexagonal based inserts or the field of the hydraulic and mechanic tools and the DIY field in order to grab and twist hexagonal or circular sections.

Specifically it relates to an innovative diaphragm tightening apparatus provided with a group of teeth arranged in coplanar, synchronized, convergent movements towards a central junction and capable of tightening in a stable and equal way elements from different sections namely nuts and bolts, rods and other objects, working in a circular way around them with a progressive reduction in the diameter of the inner lumen.

### BACKGROUND

The hand tools capable of adapting to variable sections of nuts and bolts are few: the adjustable spanner provided with screw tightening, available for at least a century, works only along two sides (two corners of the nuts), is heavy, bulky and, with regards to the less professional models, it easily loosens.

Parrot's jaw pliers, together with the self-locking pliers, grip any section but with knurled teeth which damage the object to twist and usually grip only two or three points of the bolt. It exists an apparatus made of a bundle of little cylindrical rods contained in a metallic glass capable of grabbing in a quite damaging way nuts heads with different diameter.

Over the last few years some tightening pliers for nuts, with reference to FIG. 1, have been produced and spread, provided with six parallelepiped shaped teeth which can move forward and backward in radial direction towards the centre of the object to be tightened with a mechanic movement similar to that of the mandrels of the common household drills; each of these spanners or pliers can grip nuts whose side is not smaller than the width of the teeth, but the increase in the nut diameter, the support surface of the teeth do not vary and the grip on the side of the nuts of the larger diameters rapidly decreases. Moreover, within these apparatus, in the twisting phase, the tangential thrust on the teeth rapidly becomes damaging to the spanner itself, hence it is difficult to twist a range of diameters no longer than ten millimetres.

The advantage in using these pliers and spanners (all produced in at least two graduated versions in order to include the most common diameters), in spite of a certain encumbrance in their mechanics, lies in the lightness and the portability compared to the issue of carrying a whole set of different diameters spanners.

The usage of such hand tools, less strong and accurate than the mono-diameter professional ones, concerns almost entirely the domestic field. In the diaphragm closure of the photographic lens (which has not to be mistaken for that connected with the present deposit): the plates overlap in a semi-coplanar way and have a fixed fulcrum and a leverage point of action activated by a movable rim, but these plates do not converge sliding one next to the other, on the contrary they partially overlap.

### SUMMARY

The aim of this disclosure is to produce a device connected to pliers, spanner or an electronic hand tools head with adjustable diameter, allowing a firm grip, in order to grip, tightening and/or twisting mainly hexagonal section objects, aimed at solving the above-mentioned inconveniences and acting equally on all the lateral surfaces of hexagonal objects namely nuts and bolts, adapting to different diameters.

Moreover, concerning this application, lying the lateral surfaces of the six teeth of the spanner on all the six lateral surfaces of these objects, a greater new distribution of the stress is produced along with a firm and strong, but not damaging, tightening.

The present invention displays two alternative embodiments, which permit to avoid the already-mentioned technical problems. Particularly, in the pliers solution, the tightening guided by two hand levers permit, temporarily loosening the grip of the teeth onto the nut, to keep on with the twisting within several stages, without extracting and repositioning the pliers around the object.

These and other aims are obtained by means of the specific diaphragm closure tightening of the device as it is described in the following description.

### BRIEF DESCRIPTION OF THE DRAWINGS

It will be referred to the attached figures in which:

FIG. 1 is an overview of a tightening device according to the prior art;

FIG. 2 is the favourite chosen pattern for the device according to the present disclosure;

FIG. 3A is the device of FIG. 2 in the complete closing position;

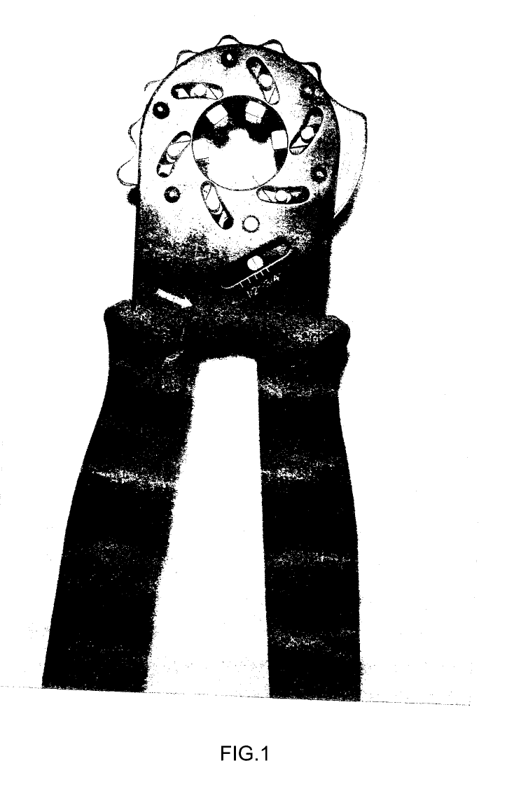

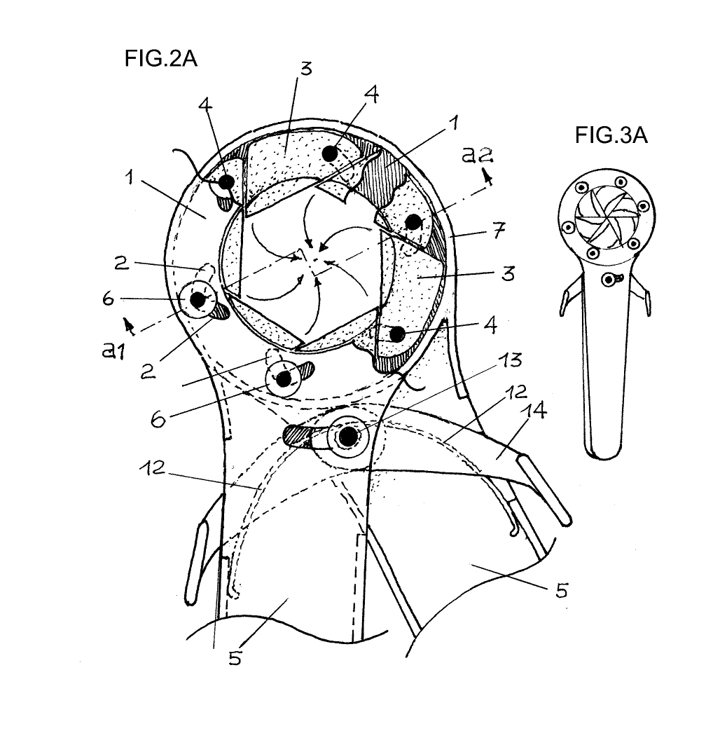

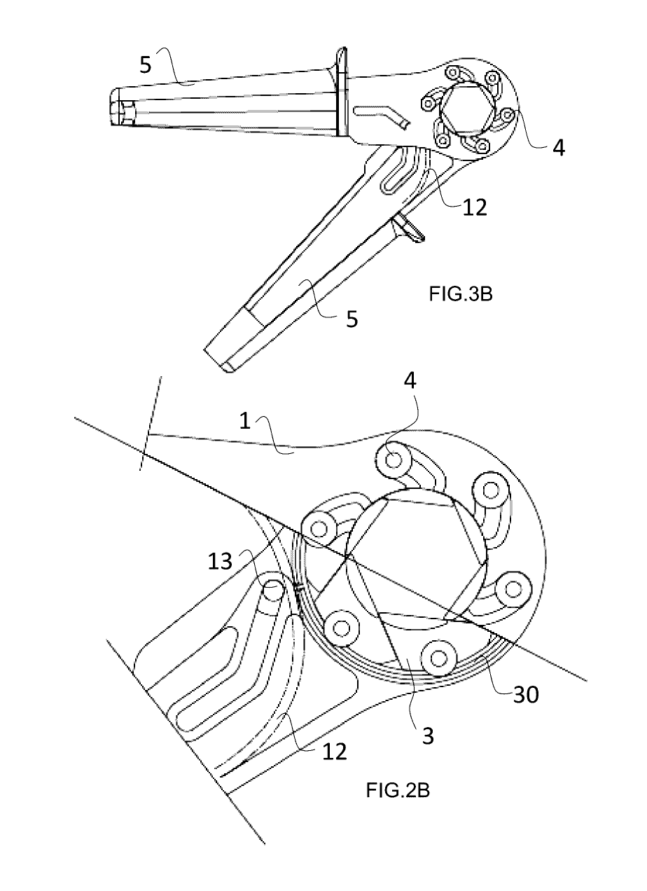

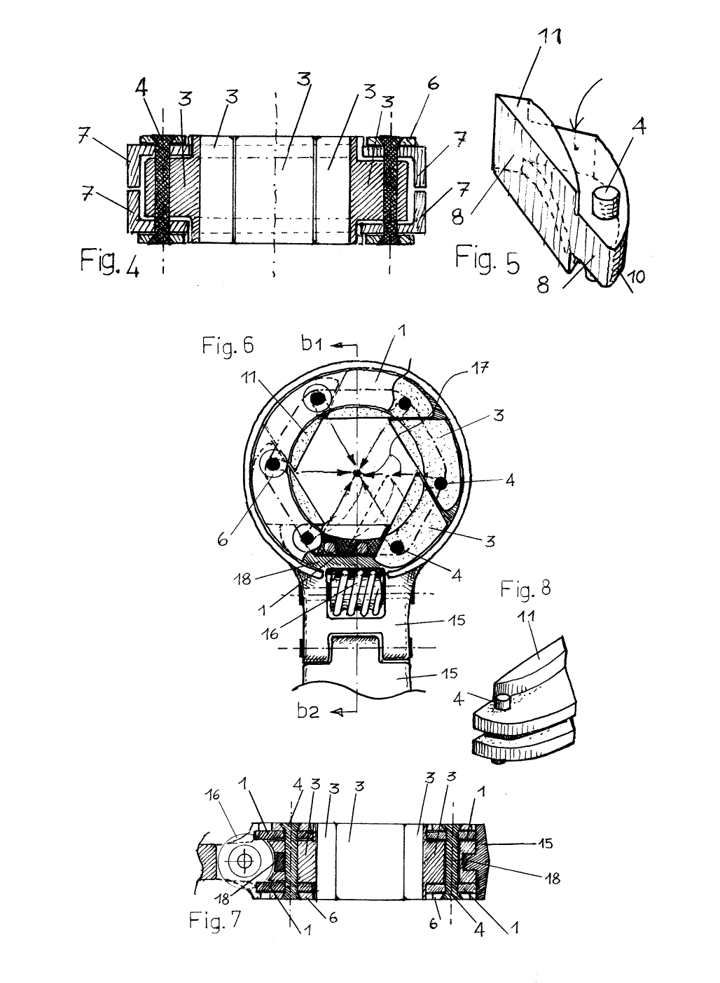

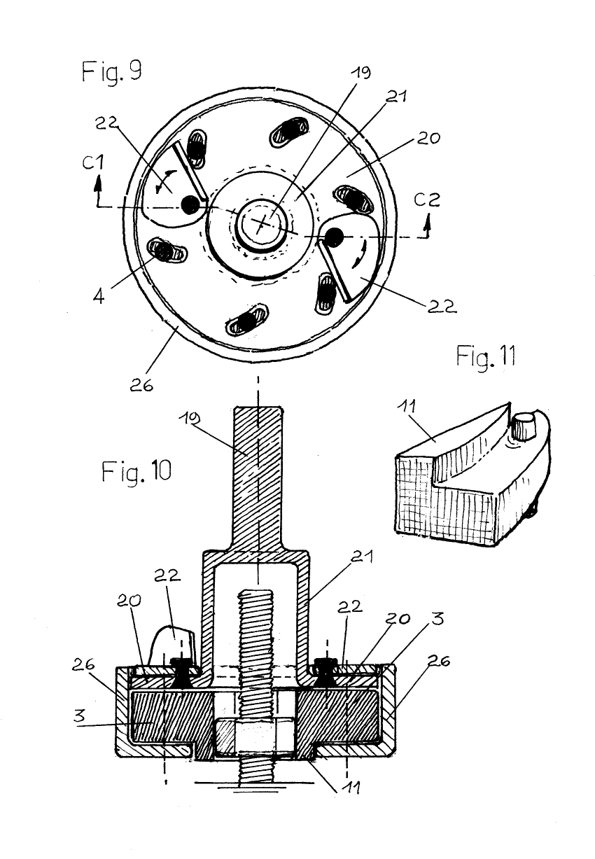

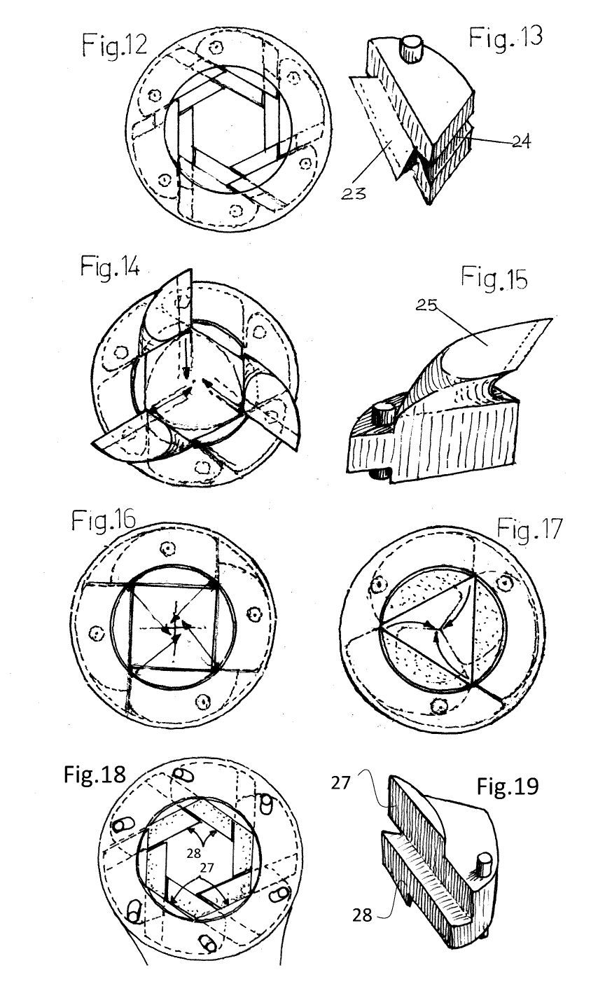

FIGS. 2B and 3B show an executive detail of the embodiment, the rail joint, shown in FIGS. 2A and 3A above described;

FIGS. 4 and 5 show a sectional view of a second executive detail, the group of teeth and rims, and a third executive detail, the tooth, of the device shown in FIG. 2, respectively.

FIG. 6 is a second executive pattern of the device according to the invention;

FIG. 7 is a lateral sectional view of FIG. 6;

FIG. 8 is an executive detail, the tooth, of the executive pattern in FIG. 6;

FIG. 9 is a further executive variation of the device according to the present disclosure;

FIGS. 10 and 11 show a lateral sectional view and an executive detail, the tooth, of the variation shown in FIG. 9, respectively;

Fig. From 12 to 19 are executive variations of the teeth pattern of the device according to the present disclosure.

### DETAILED DESCRIPTION

Referring to the drawings, in the apparatus shown in FIG. 2A activated in this non exclusive example by a pliers leverage, a pair of low thickness rims 1, parallel and centred on an only one axis, provided with specific holes and inlays 2 are connected to two arms or lever handles 5. Within such rims is arranged a group of teeth or inlays 3 which in the illustration are six, provided each tooth with a pivot 4 whose ends make the teeth and the rims join in a movable way, crossing the thickness of the same rims in the specific inlays.

The pivots of the teeth are beaten again externally to the rims or end with equivalent retention systems 6 which run on the surface of the rims and control the parallel movement of such inlays among the planes of the rims leaving the teeth ad the rims free to move reciprocally with well defined and constrained movements. In this solution, in order to give greater stability to the system, the rims can be close laterally and externally by means of a ring edges 7 which brush each other and include the inlays or teeth.

The tangential and converging movement of the handles makes the rims connected to them rotate in relative opposite way (clockwise and anticlockwise) dragging the teeth, by means of specific inlays, which are pointed according to symmetrical and opposed angles, towards the central axis of the device producing the progressive reduction and, acting in the opposite direction, the increase in the tightening lumen of the device.

FIG. 3A shows the described pliers completely closed. The divergent movement of the handles acts instead in the opposite direction, opening the diaphragm lumen and stopping the tightening of the device on the object constrained in the very lumen.

FIGS. 2B and 3B show executive detail of the embodiment, shown in FIGS. 2A and 3A, previously described.

Particularly, it is clear that the device according to the invention preferably comprises a male-female coupling 30, in runner-rail pattern, realized on sections of the circumference of the contact area between the two rims 1.

Such solution further enhances the stability of the device as it conducts the rims movement, limiting deformations or misalignment between them.

Section a1/a2 of FIG. 4 shows the articulated part of the mechanism. In this way, a tiny opening in the diaphragm make it possible to replace the teeth of the spanner on other sides of the object to be moved in order to finish the torsion without extracting the pliers from the object. The teeth in this very shape FIG. 5 are provided with two plane surfaces, a forward one 8 and a rear one 9 with a 60 degrees junction angle; the forward one leaning against the side of the object which has to be twisted and acts as a support to the rear surface of the tooth facing it; the rear surface runs in parallel and in contact with the forward surface of the following tooth; the clockwise or anticlockwise order of the sequence of such surfaces is not relevant.

When the handles or leverage open or close, the pivots move forwards or backwards in radial direction, whereas the teeth, each of them being also in contact with the preceding and the following one, make a compound movement: translational (radial and convergent) being conducted by the pivot and a rotative movement hinged on such pivot (clockwise or anticlockwise). Such rotative movement is caused by the contact with reciprocal sliding between the contiguous sides of the teeth each of which is constrained by three holds, one imposed by the pivot and the other two produced by the contact with the adjacent teeth, hence such geometry permitting the specific and original diaphragm closure of the described device.

The configuration of the other surfaces 10 of the tooth, fulfil the requirements of minimal encumbrance of the hand tool diameter; however other configurations are available.

The bilateral extensions of the working surface of the teeth 11 connect to the external surface of the rims and further expand the contact junctions between the tooth and the section to be tightened, but they are not essential to the functioning of the spanner.

In the connection area among handles and rims, in a dead zone a spring 12 can be placed aimed at making the handles divergent opening easier (in opposition to the grip of the hand closing them). In the present solution such spring is wound up around a mobile pivot 13 with extremes ending with support rivets contributing to the coplanar stability of the two rims stabilizing the very spring. In such version it is possible to use the pivot above-mentioned as a tightening screw designed to block the closing of the spanner within some exact diameters or use such pivot as a fulcrum of surfaces 14 with eccentric edges with respect to such pivot whereby creating blocking positions of the device in a particular position.

FIG. 6 shows a configuration of the teeth joint different from that of FIG. 2, as an example applying such a different mechanism on a one arm spanner 15 with an non exclusive rims joint: a never-ending screw 16.

In the variation of the device shown in FIG. 6 and in the section b1/b2 in FIG. 8 the teeth are dragged into a linear movement 17 in a direction and in the opposite direction from the rim similarly to what occurs in the device of FIG. 12 and make a tangential movement with respect to the centre of the device sliding on the sides of the polygonal rail 18 which is connected to the lever arm.

A different movement device shown in fig from 9 to 11 of the preceding tightening systems is equipped in order to be inserted into the head of a electronic hand-tool.

In its general meaning, such variation includes two parallel rims 1, 20 designed to contain the teeth, and counter-rotating with respect to a common rotation axis. In addition, such variation includes means of interference 4, 22 cooperating with the rims in order to allow a grip condition of the device wherein the group of teeth is fixed in a centripetal direction with respect to the axis and an opening condition wherein the group of teeth is movable in a centrifugal direction with respect to the rotation axis.

Similarly to the preceding embodiments previously described, in this sample, each tooth being set radially with respect to the axis and comprising one two plane surfaces 8, 9 orthogonal to the rims, and being sliding with a first orthogonal surface 8 in parallel to the second orthogonal surface 9 of the preceding tooth and with a second orthogonal surface 9 in parallel to the first orthogonal surface 8 of the following tooth, so that each tooth moves among three constrains with a specific rotative and radial coplanar movement.

Such embodiment is applicable as a screwer or a end of a robotic arm wherefrom takes its twisting force by means of a transmission shaft 19, designed to connect to a simple mandrel or other twisting force. This third and not exclusive disposition of the movement actuators can be shaped in order to integrate not only the movement system of the teeth shown in FIG. 6, but also the one displayed here through mechanic joint of the teeth shown in FIG. 2A.

In FIG. 10 section c1/c2 of FIG. 9 of this type of preferred embodiment is formed by spigot joint 21 of variable length. (which can contain the excess screw, a bolt or the end of the object to be tightened), this spigot joint connects the transmission shaft to one of the rims 20, another larger spigot joint 26 whose bottom is set as a second rim activates by means of already described pivots the related teeth, shown in FIG. 11, contained within these two surfaces.

Two locks eccentrically pivoted 22 on the first rim, when activated make the device integral to the object to be twisted, forcing the two rims to jointly move.

With a different configuration of the teeth FIG. 12 and FIG. 13 the device is suitable for scratching, carving or cutting the grabbed object when the operating surface of such teeth is criss-crossed by a blade 23, passing through the proper inlays of the adjacent teeth 24, such application turning out to be useful in the split of the sheathing sections of electric cables.

In a further conficuration of the teeth of the current device, such teeth can work as parts of diaphragm valve in order to change the flow inside pipes of liquids, inert gases, dust or to expel plastic and viscous material, including metal melting, in this case the teeth would be composed of heat-resistant materials namely ceramics.

In a further configuration of the teeth FIG. 14 of the described device whereby it is possible to use extensions 25 of said teeth FIG. 15 outside the retaining rims through which acting like a cutter with variable diameter on the surfaces to be dug.

It is possible to shape the described apparatus according to a variable number of teeth FIG. 16 and FIG. 17, wherefore changing the angle of the surfaces between the forward and the rear sliding surfaces of the teeth.

With reference to FIGS. 18 and 19, it is shown a further variation of the teeth embodiment, which allows the tightening of an object through a shorter movement of the device.

In this example, the forward surface of each tooth, that pointed towards the object to be tightened, comprises a step which define two grabbing surfaces 27 and 28. Such surfaces are mutually parallel and orthogonal to the parallel surfaces and deploy at different radial distance from The rotative axis of the rims so as to grab, with the same group of teeth, objects with different diameters.

The present invention, until now described with reference to preferred embodiments, should not be considered as restricted to that described above and shown on the drawings, many modifications being conceivable without departing from the spirit and scope of the appended claims.

1. A gripping device comprising:
a group of teeth;
two parallel planes designed to encircle a group of teeth, said planes being orthogonal and counter-rotating with respect to a common axis;
means of interference aimed at cooperating with said planes in order to provide the condition for gripping the device, wherein the group of teeth is movable in a centripetal direction with respect to the axis, and an opening condition, wherein the group of teeth is movable in a centrifugal direction with respect to the axis,
wherein
each tooth is set radially with respect to the axis and comprises a first and a second plane orthogonal to said parallel planes, said first and second surfaces orthogonal converging to a common corner and defining an included angle measuring the fraction of a round angle divided by the number of the teeth,
each tooth slides with a first orthogonal surface in parallel to the second orthogonal surface of a preceding tooth and with the second orthogonal surface in parallel to the first orthogonal surface of a following tooth, in order that each tooth moves amid three constraints with a specific coplanar, rotating and radial movement,
from each of said two parallel planes corresponding levers branch off, connected to one another in a fulcrum provided with elastic means of counter-action aimed at keeping the levers apart once the device is open,
and wherein such fulcrum is designed to cooperate with a bilateral lever and blocks such levers in a plurality of gripping positions, each corresponding to a different approach of such levers.

2. A gripping device comprising:
a group of teeth;
two parallel planes designed to encircle a group of teeth, said planes being orthogonal with respect to a common axis;
means of interference aimed at cooperating with such planes in order to provide the condition for gripping the device wherein the group of teeth is movable in a centripetal direction with respect to the axis, and an opening condition, wherein the group of teeth is movable in a centrifugal direction with respect to the axis,
wherein
each tooth is set radially with respect to the axis and comprises a first and a second plane orthogonal to said parallel planes, said surfaces orthogonal converging to a common corner and defining an included angle measuring the fraction of a round angle divided by the number of the teeth,
each tooth slides with a first orthogonal surface (8) in parallel to the second orthogonal surface (9) of a preceding tooth and with the second orthogonal surface in parallel to the first orthogonal surface of a following tooth, in order that each tooth moves amid three constraints with a specific coplanar, rotating and radial movement,
both parallel planes branch off into a sole arm and may rotate by means of a never-ending screw, wherein on each tooth a location is obtained where to host a polygonal rail integral to said arm so that, depending on the direction of the sense of rotation of the never-ending screw, the polygonal rail interferes with the shape of the teeth producing the approach or separation of the teeth.

3. A device as per claim 1 or 2, wherein each tooth is provided with one or more extensions from the first orthogonal plane towards the outer space of the area included between the two parallel planes.

4. A device as per claim 1 or 2, wherein the first orthogonal plane is provided with a protrusion in correspondence to the area comprised between the two parallel planes shaped with a such a design to allow, when in use, to scratch, carve or cut an object designed to be in contact with said plane, and wherein on the second orthogonal plane a location is obtained, shaped with a design complementary to said protrusion.

5. A device as per claim 1 or 2, wherein each tooth of said group of teeth is provided with a protrusion which overhangs from a surface parallel to one of the parallel planes towards the outer area included within said two planes, wherein said protrusion comprises a cutting area lying along a plane essentially parallel to said planes.

6. A device as per claim 1 or 2, wherein the first orthogonal plane of each tooth of said group of teeth comprises a first and a second gripping surface parallel one to the other and orthogonal to the parallel planes, said first and second gripping surfaces being displaced at different radial distance from the common axis so as to grip with the same number of teeth objects with different diameters.

7. A device as per claim 1 as 2, wherein said group of teeth comprises six teeth.
